(19) United States
(12) Patent Application Publication
(10) Pub. No.: US 2011/0082600 A1
(43) Pub. Date: Apr. 7, 2011

(54) Process And Device To Operate Continuously A Solar Array To Its Maximum Power

(76) Inventor: Antoine Capel, Goyrans (FR)

(21) Appl. No.: 12/977,323

(22) Filed: Dec. 23, 2010

Related U.S. Application Data
(63) Continuation of application No. PCT/EP2009/001295, filed on Feb. 24, 2009.

(51) Int. Cl. G06F 1/26; G06F 17/11

(52) U.S. Cl. 700/297; 703/2

(57) ABSTRACT

A process which forces a solar array (5) to operate permanently at its maximum power point MPP. This feature is available using a microprocessor (1) which receives permanently the amplitudes of operating point coordinates, a solar array voltage Vsa and current Lsa and its temperature T. The microprocessor (1) computes, using this data, the MPP of the solar array, whatever are the environmental conditions and ageing, and uses the MPP voltage Vmpp as the reference of a series or a shunt conventional power regulator (7) to force the solar array (5) to operate at this MPP. The MPP is computed solving one, two, or three unknown equation system, depending on the type of the power regulator managing the solar array voltage and the temperature, to get the electrical characteristics defining the power characteristics and solving the equation dP/dv=0.

### CROSS-REFERENCE TO RELATED APPLICATIONS

This application is a continuation application of international application PCT/EP2009/001296 filed Feb. 24, 2009.

### DESCRIPTION

### Object of the Invention

The object of the present invention is a process and a device able to operate continuously a solar array to its maximum power point (MPP).

The process starts from a simplified set of equations which defines the performance of the solar panel, and by using those equations the maximum power point voltage is identified. The equations require four parameters to be known, A, i_{sc} or V_{oc}, i_{R} and T. The temperature T is permanently available from a temperature sensor with the other three parameters obtained in different ways.

In addition, the invention includes solving a three unknown equation system using three operating points of the electrical characteristics of the solar array along with its temperature. At the first switch on of the system, the unknown parameters of the electrical characteristic of the solar panel are measured by forcing a MPP regulator to regulate successively the solar array at different proportions of the open circuit voltage or its operating voltage before activation of the MPP regulator. Also, computation of i_{R} and A are accomplished using the measured temperature, and result in obtaining i_{sc} by solving only one unknown equation system.

In the case where the apparatus uses a Sequential Switching Shunt (or Series) Regulator the parameters are immediately available with the knowledge of the coordinates of the running point and the short circuit current i_{sc} (shunt regulator) or the open circuit voltage V_{oc} (series regulator).

It's another object of the present invention to include a device to carry out the process of the invention. This device processes previous measurements obtained to determine the running coordinates i_{SA} and v_{SA} of the solar array and its temperature T. When a voltage of the MPP is known, it is applied as a reference command to a conventional power conditioning unit, in continuous or sampling mode, for managing the solar array. This device requires the use of a microprocessor whether integrated or not in the power conditioning unit.

Therefore, the present invention is related with solar arrays and particularly with those processes or devices designed to improve the performance of the solar array.

### BACKGROUND OF THE INVENTION

Solar arrays are intensively used nowadays in space and terrestrial power systems by their ability to be independent of any electrical distribution network. They supply energy to local or mobile equipments in an autonomous way.

The difficulty rises when the designer of the power system looks to operate the solar array at its maximum power point (called MPP) for cost and mass reduction reasons. All systems at the present time achieve this objective by implementing a tracking algorithm (called M.P.P.T) in the control loop of the unit in charge of managing this energy source.

At the time being only one concept offers this feature but it requires an interruption of the distributed voltage as the proposed principle calls for an algorithm imposing the measurements of 4 points of the electrical characteristics of the solar array in order to build up the equations of straights lines which give access to 2 derivatives of the electrical characteristic which allow identification of the MPP.

Therefore the objective of the present invention is to overcome the difficulties found up to now in order to operate a solar array at its maximum power point without interruption of the distributed voltage. In addition, the present invention includes a device composed of a stand alone module connected to a power regulator, series or shunt type power cell. The device is able to operate a solar array to its MPP according to the process of the invention, if this condition is accepted by the users, in a permanent way without any discontinuities in the distributed voltage.

It is known from the state of the art a document WO 2007/113358 in which is disclosed a circuit and method for monitoring the point of maximum power for solar energy sources wherein the circuit is designed for continuous, rapid and effective monitoring of a solar or equivalent source in order to successfully operate at its point of maximum power (PMP) without interrupting the supply of electricity to users, WO 2007/113358 includes a conventional power-regulating structure of series or parallel type, governed by an independent module capable of calculating the voltage and current coordinates of the PMP (VPMP, IPMP) by applying an iterative algorithm and/or graphic methods.

### EXPLANATION OF THE INVENTION

The principle of the invention is to define the electrical characteristics v(i) of the operating solar array in its working conditions, that are the cell temperature and ageing and the sun illumination, in order to derive the coordinates i_{MPP} and v_{MPP} of the MPP (maximum power point).

In a NASA study contract, in the eighties, Tada and Carter arrive to the conclusion that the solar cell effect results from the combined contributions of two processes. The equivalent electrical model which describes very well these processes is detailed on FIG. 1. A carrier generation and recombination process due to a flux of photons in the space charge volume of the p-n junction and represented by the diode D_{R} and the current i_{R}. A diffusion process is induced by the carrier concentration across the junction and is represented by the diode D_{D} and its current i_{D}. The flux of photons is represented by a current source supplying the illumination current i_{L}. The shunt resistance materializes the bulky defects of the cell which acts as a current leakage. The shunt resistance R_{Sh} is active only when transients are applied on cell terminals. The series R_{S} resistance represents the ohmic effect introduced by terminal connections and material resistivity. If i_{SA} is the current delivered by the cell to the load R₀, and i_{Rsh} is the current across the shunt resistance R_{Sh}, it comes at any time t:

[symbol]

The currents of the above equation are shown in the electrical equivalent circuit of FIG. 1. In addition, these currents can be expressed as a function of the voltage v across the diodes:

[symbol]

(1.2)

where T is the cell temperature in Kelvin, q=1.6 10⁻¹⁹ Cb, k=1.38 10⁻²³ and currents i_{R0} and i_{D0} respectively are the saturation currents of diodes D_{R} and D_{D}. The electrical characteristic i_{SA} (v_{SA}) of the solar cell corresponds to:

[symbol]

(1.3)

That is the implicit relationship (1.4):

$${i}_{SA} ( t ) = {i}_{L} - {i}_{R 0} ( exp ( \frac{q ( {v}_{SA} ( t ) + {R}_{SA} {i}_{SA} ( t ) )}{kT} ) - 1 ) - … - {i}_{D 0} ( exp ( \frac{q ( {v}_{SA} ( t ) + {R}_{SA} {i}_{SA} ( t ) )}{2 kT} ) - 1 ) - \frac{{v}_{SA} ( t ) + {R}_{SA} {i}_{SA} ( t )}{{R}_{Sh}}$$

The handling of such an equation is not straightforward and calls for a time consuming iteration process. In reality the shunt resistance is always higher than 10̂5 Ohm, and its influence can be neglected with regard to the diode currents. As well the series resistance always has a very low value in order to avoid ohmic losses, affecting the cell efficiency. Therefore these two parameters cannot be considered and the electrical characteristics of a solar panel composed of m strings, each one with n series cells, is expressed by:

$${i}_{SA} ( t ) = m ( {i}_{SC} ( t ) - {i}_{R 0} ( exp ( \frac{{qv}_{SA} ( t )}{nkT} ) - 1 ) - {i}_{D 0} ( exp ( \frac{{qv}_{SA} ( t )}{2 nkT} ) ) \\ {P}_{SA} ( t ) = {v}_{SA} ( t ) {i}_{SA} ( t ) \qquad ( 2.1 )$$

This equation depends on 4 parameters: the short circuit i_{SC}, the dark currents i_{R0} and i_{D0} of the cell, and the temperature T of the panel.

The handling of such an electrical model has resulted to be tedious and unpractical. Tada and Carter have worked on a simplified model, still representative of the electrical behaviour of a solar panel but more practical. Such a cell model is represented in FIG. 2. The recombination and diffusion diodes are replaced by an equivalent diode D, characterized by a dark current i_{R} and a shape factor A, such as:

$${i}_{R 0} ( exp ( \frac{{qv}_{SA} ( t )}{nkT} ) - 1 ) + {i}_{D 0} ( exp ( \frac{{qv}_{SA} ( t )}{2 nkT} ) - 1 ) = {i}_{R} ( exp ( \frac{{qv}_{SA} ( t )}{AnkT} ) - 1 ) \qquad ( 2.2 )$$

According to FIG. 2, It can be established, by developing to the first order the exponential terms in this relationship that:

$${i}_{R 0} + {i}_{D 0} = {i}_{R} \\ {i}_{R 0} + \frac{{i}_{D 0}}{2} = \frac{{i}_{R}}{A} \qquad ( 2.3 )$$

It can also be deducted that the parameters i_{R} and A are both dependent on the dark currents of the diodes which represent the recombination and diffusion processes. On other terms:

$${i}_{R} = {i}_{R 0} + {i}_{D 0} \\ A = \frac{{i}_{R 0} + {i}_{D 0}}{{i}_{R 0} + \frac{{i}_{D 0}}{2}} \qquad ( 2.4 )$$

The parameter i_{R} is temperature dependent according to the relationship:

$${i}_{R} ( T ) = {KT}^{3} exp ( - \frac{{E}_{G}}{kT} ) \qquad ( 2.4 bis )$$

In this equation, K is a constant depending on the cell material and E_{G} is the silicon energy bandgap which is equal to 1.153 eV. The parameter A can be considered as not being temperature dependent. Furthermore, if the series resistance R_{S} is now neglected as it is the major objective of any manufacturer to reduce its value which affects the efficiency of the cell, the electrical characteristic of a solar panel becomes:

$${i}_{SA} ( t ) = m ( {i}_{SC} ( t ) - {i}_{R} ( exp ( \frac{{qv}_{SA} ( t )}{AnkT} ) - 1 ) \\ {P}_{SA} ( t ) = {v}_{SA} ( t ) {i}_{SA} ( t ) \qquad ( 2.5 )$$

The 4 parameters i_{SC}, i_{R}, A and T have to be known permanently in order to get access to the analytical form of the electrical characteristic (2.5) ruling the operation of the solar array at time t with the existing environmental conditions. The coordinates of the MPP (v_{MPP}, i_{MPP}) are set by solving the equation:

$$\frac{d {P}_{SA}}{d {v}_{SA}} = \frac{nAkT}{q} ( Log ( \frac{{mi}_{SC} - {i}_{MPP}}{{mi}_{R}} ) - \frac{{i}_{MPP}}{{mi}_{R} ( 1 + \frac{{i}_{SC} - {i}_{MPP}}{{mi}_{R}} )} ) = 0 \qquad ( 2.6 )$$

which conducts to the identification of the MPP voltage, that is:

$${v}_{MPP} = \frac{nAkT}{q} Log ( 1 + \frac{{mi}_{SC} - {i}_{MPP}}{{mi}_{R}} ) \qquad ( 2.7 )$$

These three steps lead to the knowledge of the MPP voltage. They are realized by a microprocessor which processes measurements performed to know the running coordinates i_{SA} and v_{SA} of the solar array and its temperature T. These measurements will give access to the actual values of parameters mi_{R} and nAkT/q. As k/q is a physical constant equal to 8.625 10⁻⁵, and the measured temperature T is also available, the saturation currents i_{Ro} and i_{Do} of diodes D_{R} and D_{D} as well as the parameter A can be immediately computed solving the mathematical system of the 2 equations detailed on (2.4). The constant K as well can be computed and stored in the memory of the microprocessor, by solving (2.4 bis). When the voltage of the MPP is known, it is applied as a reference command to a conventional power conditioning unit, shunt or series type, in continuous or sampling mode, thus managing the solar array. This latter is forced to operate at the MPP if the user network requires it.

### EXPLANATION OF THE FIGURES

Further characteristics and advantages of the invention will be explained in greater detail in the following detailed description of an embodiment thereof which is given by way of non-limiting example with reference to the appended drawings, in which:

FIG. 1 shows an equivalent electrical circuit representing a solar cell;

FIG. 2 represents a simplified model of a solar cell;

FIG. 3a shows a block diagram of a series (a) power conditioning or regulating unit;

FIG. 3b shows a block diagram of shunt power conditioning or regulating unit;

FIG. 4 shows a curve wherein three operating points M₁, M₂ and M₃ have been obtained at different fractions of v_{OC};

FIG. 5a shows the new curve obtained when parameters nAkT/q, and mi_{R} are required to be refreshed when Di=(i₁₋ᵢ_{MPP1}) is positive. The measurements of points M₂(v₂,i₂) and M₃(v₃,i₃) are sufficient as point M₁(v₁,i₁) is immediately available;

FIG. 5b shows the new curve obtained when parameters nAkT/q, and mi_{R} are required to be refreshed when Di=(i₁−i_{MPP1}) is negative. The measurements of points M₂(v₂,i₂) and M₃(v₃,i₃) are sufficient as point M₁(v₁,i₁) is immediately available; and

FIG. 6 represents a schematic block diagram of an S3R, shunt type topology, involving 3 modules.

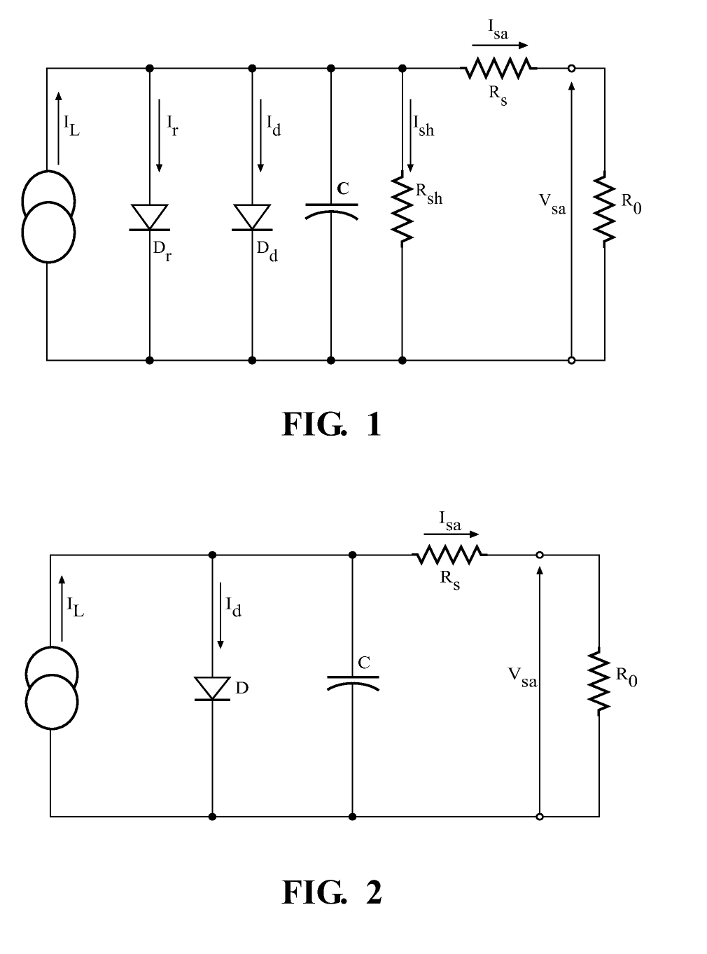

### PREFERRED EMBODIMENT OF THE INVENTION

The process of the invention consists of a computation of V_{MPP}. In other words, it seeks to identify the voltage of the MPP 2 at every change of the environmental conditions. This process involves three successive operations.

The first operation is the identification of the new analytical form i_{SA}(v_{SA}) of the electrical characteristics of the solar array 5 according to equation:

$${i}_{SA} ( t ) = m ( {i}_{SC} ( t ) - {i}_{R } ( exp ( \frac{{qv}_{SA} ( t )}{nAkT} ) - 1 ) ) \\ {P}_{SA} ( t ) = {v}_{SA} ( t ) {i}_{SA} ( t ) \qquad ( 2.8 )$$

wherein:
i_{SC} corresponds to the short circuit current;
i_{SA} corresponds to the current of the solar array 5;
T corresponds to the temperature;
v_{SA} corresponds to the voltage of the solar array 5; and
P_{SA} corresponds to the power of the solar array 5.

This step will be completed when the 4 parameters i_{SC} , i_{R}, A and T are identified. It must be noticed that the parameters A and T are always available solving the product nAkT/q. Therefore the knowledge of the temperature T is necessary to identify A. The temperature T is permanently measured via a thermal sensor and known by the microprocessor 1. The parameter i_{R} is also available as the constant K has been computed at the switch on of the process and stored in the microprocessor memory.

The second operation solves the extreme condition which characterizes the existence of a maximum of the solar array power P_{SA}; that is:

$$\frac{d {P}_{SA}}{d {v}_{SA}} = \frac{nAkT}{q} ( Log ( \frac{{mi}_{SC} - {i}_{MPP}}{{mi}_{R}} ) - \frac{{i}_{MPP}}{{mi}_{R} ( 1 + \frac{{i}_{SC} - {i}_{MPP}}{{mi}_{R}} )} ) = 0 \qquad ( 2.9 )$$

Solving this relationship conducts to the knowledge of the MPP current i_{MPP}.

The last operation is the computation of the MPP voltage 2 and its delivery under the form of an analogue reference signal for a power regulator 7; that is:

$${v}_{MPP} = \frac{nAkT}{q} Log ( 1 + \frac{{mi}_{SC} - {i}_{MPP}}{{mi}_{R}} ) \qquad ( 2.10 )$$

Once the voltage of the MPP 2 has been identified, it becomes the reference voltage of a standardized power regulator 7, series or shunt type, controlling the operating point of the solar array 5.

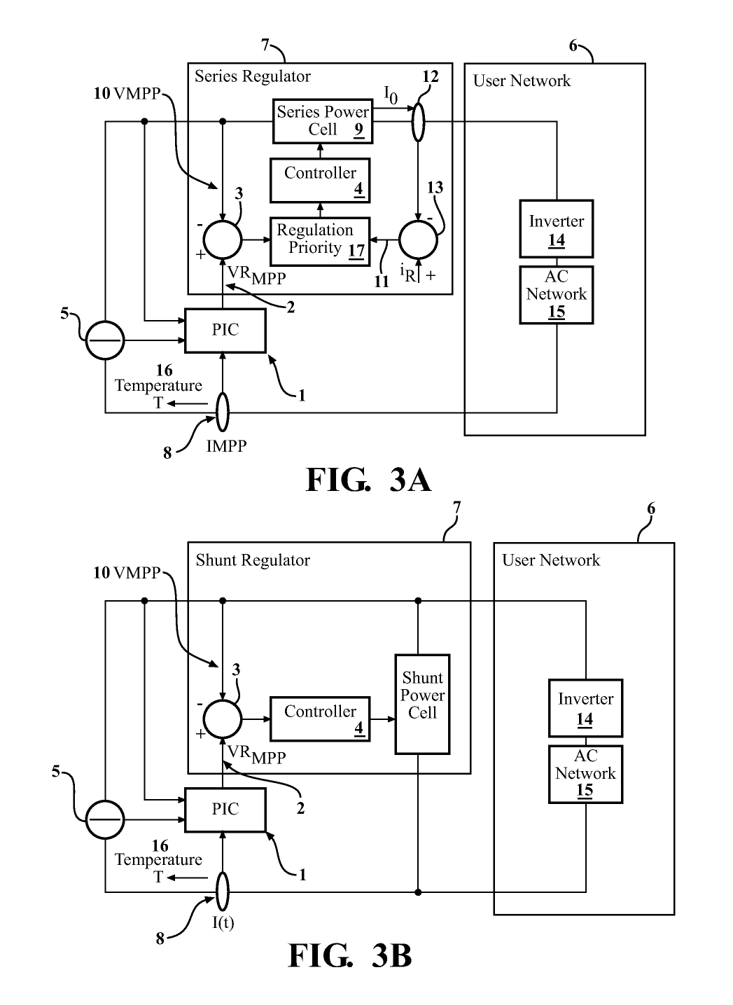

On FIG. 3 are detailed the block diagrams of a series (a) and a shunt (b) power conditioning unit. The apparatus involved in this invention is inside the module “Calcul du MPP”. The power regulator 7 does not require any modification to be inserted in the MPP regulation. It regulates its input voltage in the case of a series power cell 9 and the distributed voltage in the case of a shunt regulator.

The references assigned to the different parts correspond to:
(1) Microprocessor. Device object of the invention in charge with obtaining the V_{MPP};
(2) The voltage of the maximum power point provided to the power conditioning unit;
(3) An element in charge of subtracting the voltage of the MPP from the existing Voltage MPP;
(4) A controller;
(5) A solar array;
(6) A user network;
(7) A power conditioning unit, shunt/series type regulator;
(8) A current transformer;
(9) A series power cell;
(10) Existing voltage of the MPP;
(11) A current value obtained from subtracting I_{R} from the Iₒ provided by the series power cell;
(12) A current transformer for measuring the current provided by the series regulator;
(13) A battery;
(14) An inverter;
(15) An AC Network;
(16) Temperature value; and
(17) Regulation priority.

### Computations of nAkT/q, m i_{SC} and mi_{R}

As the temperature T is permanently available from a temperature sensor installed on the solar panel, the process to compute these three parameters nAkT/q, m, i_{SC}, and mi_{R} result from solving a three unknown equation system using three operating points M₁(v₁,i₁), M₂(v₂,i₂), M₃(v₃,i₃) of the electrical characteristics of the solar array 5. It comes:

$$\begin{matrix}{i}_{1} = m ( {i}_{SC} - {i}_{R} ( exp ( \frac{q}{nAkT} {v}_{1} ) - 1 ) & ( 2.11 ) \\ {i}_{2} = m ( {i}_{SC} - {i}_{R} ( exp ( \frac{q}{nAkT} {v}_{2} ) - 1 ) & ( 2.12 ) \\ {i}_{2} = m ( {i}_{SC} - {i}_{R} ( exp ( \frac{q}{nAkT} {v}_{3} ) - 1 ) & ( 2.13 )\end{matrix}$$

As shown in (2.14) and (2.15), by doing (2.12)−(2.11) and (2.12)−(2.13) the parameter i_{SC} is eliminated.

$$\begin{matrix}{i}_{1} - {i}_{2} = {mi}_{R} ( exp ( \frac{q}{nAkT} {v}_{2} ) - exp ( \frac{q}{nAkT} {v}_{1} ) ) & ( 2.14 ) \\ {i}_{1} - {i}_{3} = {mi}_{R} ( exp ( \frac{q}{nAkT} {v}_{3} ) - exp ( \frac{q}{nAkT} {v}_{1} ) ) & ( 2.15 )\end{matrix}$$

In addition, by implementing the ratio (2.14)/(2.15) the parameter mi_{R} is eliminated and the following equation f(q/nAkT) is set where only the parameter A is available. Accordingly, (2.16) is:

$$f ( \frac{q}{nAkT} ) = ( {i}_{2} - {i}_{3} ) exp ( \frac{q}{nAkT} {v}_{1} ) - ( {i}_{1} - {i}_{3} ) exp ( \frac{q}{nAkT} {v}_{2} ) + ( {i}_{1} - {i}_{2} ) exp ( \frac{q}{nAkT} {v}_{3} )$$

Solving the equation f(q/nAkT)=0, using for instance the Newton-Raphson method, gives access to the parameter nAkT/q. By letting:

$$\frac{q}{nAkT} = \frac{q}{{nA}^{j} kT} - \frac{f ( \frac{q}{{nA}^{j} kT} )}{{f}^{′} ( \frac{q}{{nA}^{j} kT} )} \qquad ( 2.17 )$$

wherein j=1 to N, being N, the number of iterations.

Accordingly, the two other parameters are available:

$$\begin{matrix}m {i}_{R} = \frac{{i}_{1} - {i}_{2}}{exp ( \frac{q}{nAkT} {v}_{2} ) - exp ( \frac{q}{nAkT} {v}_{1} )} & ( 2.18 ) \\ {i}_{SC} = \frac{{i}_{1}}{m} - {i}_{R} ( exp ( \frac{q}{nAkT} {v}_{1} ) - 1 ) & ( 2.19 )\end{matrix}$$

The knowledge of the temperature T gives access as well to the constant K as:

$$K = \frac{m {i}_{R}}{{T}^{3} exp ( - \frac{{E}_{G}}{kT} )} \qquad ( 2.19 bis )$$

and to the parameter A as nAkT/q has been computed by doing:

$$A = \frac{nAkT}{q} \frac{q}{nk} \frac{1}{T} \qquad ( 2.19 ter )$$

When a new Maximum Power Point (MPP) has to be obtained the computation of the unknown parameters i_{SC}, i_{R}, A and T can be carried out in a simplified way comprising two steps, namely (a) computing of i_{R} and A, and (b) computing i_{SC}. In other words, a simplified method for calculating a new MPP which does not require a large amount of resources, such as the Newton-Raphson method or the graphical method.

a) Computing of i_{R} and A

The computation of the parameter A is realized using a two step process. In a first step, the parameter a=nAkT/q is computed and the cell temperature T measured using a temperature sensor on the solar array 5. Then, in a second step, the microprocessor 1 executes the operation:

$$a = \frac{nAkT}{q} * \frac{1}{T} \qquad ( 2.20 )$$

The parameter i_{R} is permanently available, as the temperature T is measured by doing:

$${i}_{R} ( T ) = {KT}^{3} exp ( - \frac{{E}_{G}}{kT} ) \qquad ( 2.20 bis )$$

wherein:
K corresponds to a constant depending of the cell material; and
E_{G} corresponds to the silicon energy bandgap equal to 1.153 ev.
   The constant K has to be computed at the first process switch on and subsequently stored in a memory of the microprocessor 1. It must be recalled that the parameter i_{R} is directly available if the open circuit voltage can be measured and if the parameter nAkT/q is known. The dark current is defined by the relationship:

$${i}_{R} = \frac{{i}_{SC}}{exp ( \frac{AkT}{q} {v}_{OC} ) - 1} . \qquad ( 2.21 )$$

b) Computation of i_{SC}

As the parameters i_{R} and A have been already evaluated and stored in the microprocessor 1 and also the temperature T is available since it was previously measured, the computation of the last parameter i_{SC} requires only to solve the one unknown equation system using the coordinates i_{SA} and v_{SA} of the solar array running point. Therefore as:

$${i}_{SA} = m ( {i}_{SC} - {i}_{R} ( exp ( \frac{q}{nAkT} {v}_{SA} ) - 1 ) \qquad ( 2.13 )$$

it comes:

$${mi}_{SC} = m ( {i}_{SA} + {i}_{R} ( exp ( \frac{q}{nAkT} {v}_{SA} ) - 1 ) . \qquad ( 2.14 )$$

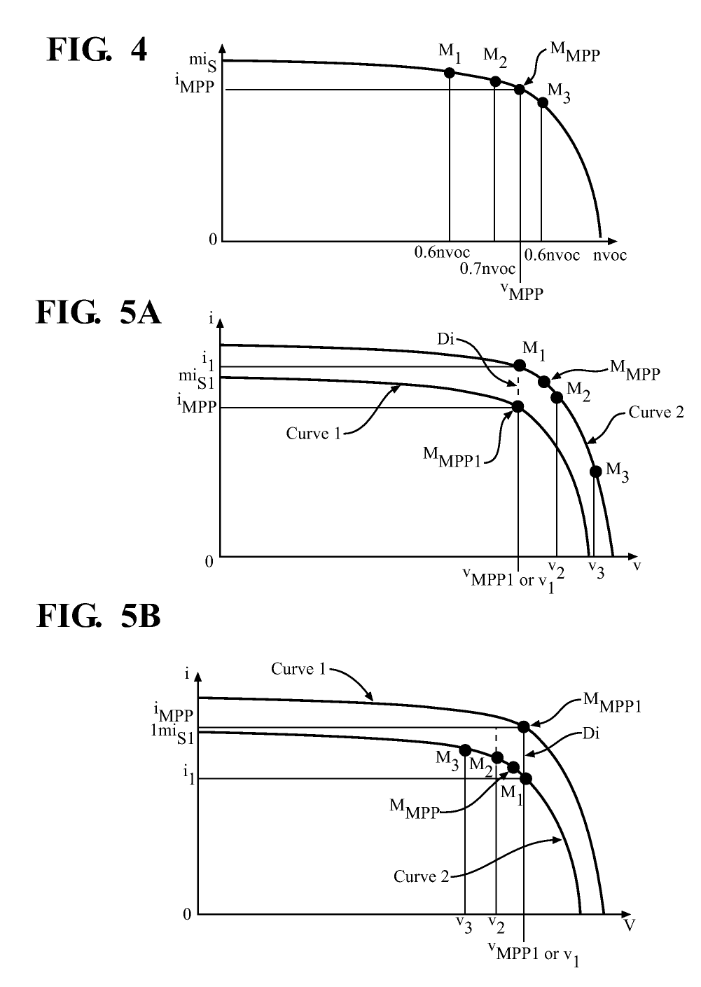

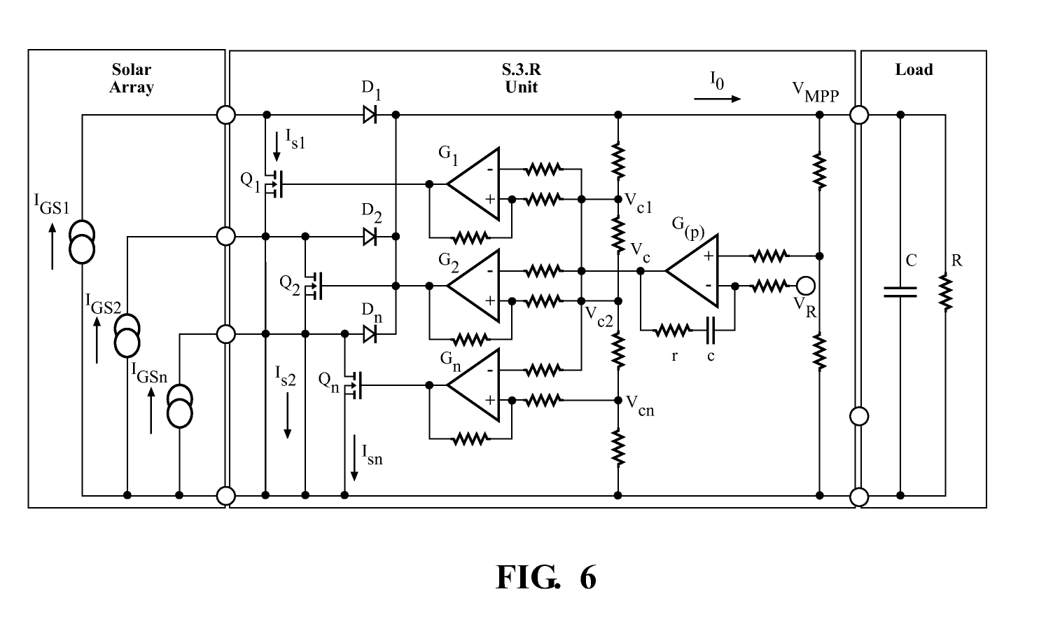

The above procedure applies at the first switch on of the system. The solar array 5 and its MPP regulator are connected to the user network 6. If the open circuit voltage nv_{OC} is available, before switching on the regulator 7, the three operating points M₁(v₁,i₁), M₂(v₂,i₂), M₃(v₃,i₃) of the electrical characteristics of the solar array 5 are measured by forcing the MPP regulator to regulate successively the solar array 5 at voltages 0.6 nv_{OC}, 0.7 nv_{OC} and 0.8 nv_{OC} as shown on FIG. 4. In practice, choosing these three points avoids disturbing effects like noise, component accuracies of the sensors, etc. will affect the measurements. The selected points must be positioned on the electrical characteristics where the current amplitudes i₁, i₂, i₃ and i_{sc} present substantial differences to eliminate all disturbing effects. The best locations have v_{oc} as maximum limit and 0.6 voc as lower limit, that is on the part of the electrical characteristics which presents the smallest curvature radius.

If the open circuit voltage is not available, the first point to be measured is M₁(v₁,i₁) before activating the MPP regulator 7. The two other points M₂(v₂,i₂), M₃(v₃,i₃) are selected by forcing the solar array voltage to 1.1 v₁ and 1.2 v₁. When the parameter v_{oc} is not available, the smallest curvature radius area is located between M₁ and v_{oc}. The positions of M₂ and M₃ are on the right part of M1 defined by 1.1ᵥ₁ and 1.2ᵥ₁.

### Computations of nAkT/q, m i_{SC} and mi_{R}

When the parameters nAkT/q and mi_{R} required to be refreshed (every month for instance), the complete procedure normally has to be applied which consists in solving a 3 unknown equation system as described in (2.2).

However, the present procedure requires only the measurement of the running point M₁(v₁,i₁) as parameters mi_{R} and A are always available by the knowledge of the temperature T. The only parameter to be computed is the short circuit current mi_{SC} or the open circuit voltage nv_{OC}. Accordingly, this computation involves to solve only one equation, one unknown system. Therefore, this computation is achieved with only one measured point. As previously mentioned, the procedure provides for a method which does not require use of a large amount of resources, such as the Newton-Raphson method or a graphical method.

The computation of the last parameter i_{SC}, requires only to solve the one unknown equation system, using the coordinates i_{SA}, and v_{SA} of the solar array running point. Therefore as:

$${i}_{SA} = m ( {i}_{SC} - {i}_{R} ( exp ( \frac{q}{nAkT} {v}_{SA} ) - 1 ) \qquad ( 2.13 )$$

It comes:

$${mi}_{SC} = m ( {i}_{SA} + {i}_{R} ( exp ( \frac{q}{nAkT} {v}_{SA} ) - 1 ) . \qquad ( 2.14 )$$

The method of the invention can be adapted to an apparatus which uses an S3R unit. The S3R unit is a Sequential Switching Shunt (or Series) Regulator 7. It involves a non dissipative power cell connected to the solar panels to force these layers to operate at a regulated voltage (the MPP is this application). This power cell insulates the solar panels from the users during a part of the switching period. In the case of a series power cell 9, the solar panels are forced into open circuit (via an active series device) or into a short circuit (via an active shunt device) in the case of a shunt power cell.

In the particular case where the power conditioning unit 7 is a Sequential Switching Shunt Regulator 7 (called S3R) type or its series equivalent power cell (called ASR) 9, the computation of the parameters of the electrical characteristics are no longer dependent on the measurement of point M₂ to generate the straight line M₁ M₂. Rather, all parameters are immediately available with the knowledge of the coordinates of the running point M₁ as this power cell shorts during part of the switching period. The solar panels and the parameter i_{SC} is immediately available in the case of a shunt topology or maintains during a part of the switching period the solar panels in open circuit. The parameter v_{OC} is also immediately available in the case of a series topology.

A block diagram schematic of an S3R, shunt type topology, involving 3 modules is shown in FIG. 4. The basic principle of such a shunt is to get an electronic switch shunting a solar panel module, in this case a FET, and to operate this switch in only two modes: open circuit or short circuit. The advantage is to eliminate power dissipation on all switches.

As these switches have only two operating states, the solar panel module is either in short circuit where the parameter i_{SC} is directly available, or is in open circuit and automatically delivering power to the users via the series diode. In that case the coordinates of point M₁ are also directly available.

As the parameters i_{SC} and i_{R} are known as well as the coordinates of the running point M₁, i.e. the voltage v₁ and the current i₁, the last parameter A is immediately available from (2.5) as:

$${v}_{1} = \frac{nAkT}{q} Log ( 1 + \frac{m {i}_{SC} - {i}_{1}}{m {i}_{R}} \qquad ( 2.15 )$$

This value is compared to the stored value. In case of a discrepancy, the procedure to refresh the parameters i_{R} and A has to be activated. In the case of a switching series power cell, the parameter directly available is the open circuit voltage v_{OC}. The running point M₁ is of course available when the series switch is ON and connecting the solar module to the users.

There is a relationship tying the open circuit voltage to the short circuit current and the parameter A. It corresponds to:

$${v}_{OC} = \frac{nAkT}{q} Log \frac{{i}_{SC}}{{i}_{R}} = na Log \frac{{i}_{SC}}{{i}_{R}} \qquad ( 2.16 )$$

The solution consists in solving directly with the microprocessor 1, the two equation system laid by (2.15) and (2.16).

Installing the whole process or this principle in an apparatus requires the use of a microprocessor 1 whether integrated or not in the power conditioning unit, or alternatively an external computing unit, for purposes of getting the values of the running point of a solar array 5 and its temperature T. The final objective is to get access to the real time electrical characteristic of the energy source and derive its MPP voltage 2. This voltage will constitute the reference voltage for a conventional power conditioning unit, involving a series or shunt power cell. This power conditioning unit will regulate the voltage of the energy source according to the reference command. The microprocessor 1 and the analogue-digital, digital-analogue devices interface the solar array 5 (or the energy source) and the power conditioning unit. It constitutes an independent module, called “Calcul du MPP”.

1. A method of operating a solar array including a microprocessor and a memory and a thermal sensor and a regulator and a power conditioning unit to its maximum power point, the method comprising the steps of:
a) identifying an i_{SA}(v_{SA}) of the electrical characteristics of a solar array according to:
$${i}_{SA} ( t ) = m ( {i}_{SC} ( t ) - {i}_{R} ( exp ( \frac{q {v}_{SA} ( t )}{nAkT} ) - 1 ) ) \\ {P}_{SA} ( t ) = {v}_{SA} ( t ) {i}_{SA} ( t ) \qquad ( 2.8 )$$
wherein:
i_{SC} corresponds to a short circuit current,
i_{SA} corresponds to a current of the solar array,
T corresponds to a temperature,
v_{SA} corresponds to a voltage of the solar array,
P_{SA} corresponds to a power of the solar array,
n corresponds to a number of series cells,
m corresponds to a number of strings,
i_{MPP} corresponds to a current at a maximum power point,
i_{R} corresponds to a dark current of an equivalent diode of a simplified solar cell model,
q corresponds to a constant value equal to 1.6 10⁻¹⁹ C,
k corresponds to is a constant value equal to 1.38 10⁻²³ JK⁻¹;
A corresponds to a shape factor of the equivalent diode D of the simplified solar cell model being calculated as
$$A = \frac{{i}_{R 0} + {i}_{D 0}}{{i}_{R 0} + \frac{{i}_{D 0}}{2}}$$
wherein:
i_{RO} is a saturation current of diode Dr of the solar cell model, and
i_{DO} is a saturation current of diode Dd of the solar cell model;
b) solving an extreme condition which characterizes the existence of a maximum of the solar array power P_{SA} according to:
$$\frac{d {P}_{SA}}{d {v}_{SA}} = \frac{nAkT}{q} ( Log ( \frac{m {i}_{SC} - {i}_{MPP}}{m {i}_{R}} ) - \frac{{i}_{MPP}}{m {i}_{R} ( 1 + \frac{{i}_{SC} - {i}_{MPP}}{m {i}_{R}} )} ) = 0 \qquad ( 2.9 )$$
to gain knowledge of i_{MPP};
c) computing a MPP voltage 2 and its delivery under the form of an analogue reference signal for a power regulator according to:
$${v}_{MPP} = \frac{nAkT}{q} Log ( 1 + \frac{m {i}_{SC} - {i}_{MPP}}{m {i}_{R}} ) ; \qquad ( 2.10 )$$
d) sensing the temperature T of the solar array using a thermal sensor;
e) determining the value of parameters nA, mi_{SC} and mi_{R} according to a three unknown equation system using three operating points M₁(v₁,i₁), M₂(v₂,i₂), M₃(v₃,i₃) which represent electrical characteristics of the solar array wherein the three unknown equation system is represented by:
$$\begin{matrix}{i}_{1} = m ( {i}_{SC} - {i}_{R} ( exp ( \frac{q}{nAkT} {v}_{1} ) - 1 ) , & ( 2.11 ) \\ {i}_{2} = m ( {i}_{SC} - {i}_{R} ( exp ( \frac{q}{nAkT} {v}_{2} ) - 1 ) , and & ( 2.12 ) \\ {i}_{3} = m ( {i}_{SC} - {i}_{R} ( exp ( \frac{q}{nAkT} {v}_{3} ) - 1 ) ; & ( 2.13 )\end{matrix}$$
f) performing the mathematical steps of (2.12)−(2.11) and (2.12)−(2.13) to eliminate the parameter i_{SC} and arrive at the following equations:
$$\begin{matrix}{i}_{1} - {i}_{2} = m {i}_{R} ( exp ( \frac{q}{nAkT} {v}_{2} ) - exp ( \frac{q}{nAkT} {v}_{1} ) ) , and & ( 2.14 ) \\ {i}_{1} - {i}_{3} = m {i}_{R} ( exp ( \frac{q}{nAkT} {v}_{3} ) - exp ( \frac{q}{nAkT} {v}_{1} ) ) ; & ( 2.15 )\end{matrix}$$
g) implementing the ratio (2.14)/(2.15) to eliminate the parameter mi_{R} and arrive at the following equation f(q/nAkT) where only the parameter A is available:
$$f ( \frac{q}{nAkT} ) = ( {i}_{2} - {i}_{3} ) exp ( \frac{q}{nAkT} {v}_{1} ) - ( {i}_{1} - {i}_{3} ) exp ( \frac{q}{nAkT} {v}_{2} ) + ( {i}_{1} - {i}_{2} ) exp ( \frac{q}{nAkT} {v}_{3} )$$
h) solving the equation f(q/nAkT)=0, using for instance the Newton-Raphson method, to get access to the parameter nAkT/q by letting
$$\frac{q}{nAkT} = \frac{q}{n {A}^{j} kT} - \frac{f ( \frac{q}{n {A}^{j} kT} )}{{f}^{′} ( \frac{q}{n {A}^{j} kT} )} \qquad ( 2.17 )$$
wherein j=1 to N with N being the number of iterations;
i) obtaining the two other parameters according to:
$$m {i}_{R} = \frac{{i}_{1} - {i}_{2}}{exp ( \frac{q}{nAkT} {v}_{2} ) - exp ( \frac{q}{nAkT} {v}_{1} )} \\ {i}_{SC} = \frac{{i}_{1}}{m} - {i}_{R} ( exp ( \frac{q}{nAkT} {v}_{1} ) - 1 ) ; \qquad ( 2.18 )$$
and characterized by;
j) solving the equation:
$$K = \frac{m {i}_{R}}{{T}^{3} exp ( - \frac{{E}_{G}}{kT} )} \qquad ( 2.19 bis )$$
using the knowledge of the temperature T to gain access to a constant K;
k) solving the equation:
$$A = \frac{nAkT}{q} \frac{q}{nk} \frac{1}{T} \qquad ( 2.19 ter )$$
to gain access to the parameter A;
l) determining when a new maximum power point is required to operate the solar array;
m) measuring a new temperature T of the solar array using the temperature sensor;
n) solving for the parameter A according to:
$$a = \frac{nAkT}{q} * \frac{1}{T} ; \qquad ( 2.20 )$$
o) solving for the parameter i_{R} according to:
$${i}_{R} ( T ) = {KT}^{3} exp ( - \frac{{E}_{G}}{kT} ) \qquad ( 2.20 bis )$$
wherein
K corresponds to a constant which depends of the cell material,
E_{G} corresponds to the silicon energy bandgap equal to 1.153 ev, and
i_{R} is directly available if the open circuit voltage can be measured and if the parameter nAkT/q is known and is defined by the relationship:
$${i}_{R} = \frac{{i}_{SC}}{exp ( \frac{AkT}{q} {v}_{OC} ) - 1} ; and \qquad ( 2.21 )$$
p) solving for the last parameter i_{SC} according to:
$$\begin{matrix}{i}_{SA} = m ( {i}_{SC} - {i}_{R} ( exp ( \frac{q}{nAkT} {v}_{SA} ) - 1 ) , and & ( 2.13 ) \\ m {i}_{SC} = m ( {i}_{SA} + {i}_{R} ( exp ( \frac{q}{nAkT} {v}_{SA} ) - 1 ) . & ( 2.14 )\end{matrix}$$

2. A method as set forth in claim 1 further defined by:
determining if an open circuit voltage nv_{OC} is available before switching on a regulator;
setting three operating points M₁(v₁,i₁), M₂(v₂,i₂), M₃(v₃,i₃) of the electrical characteristics of the solar array to 0.6 nv_{OC}, 0.7 nv_{OC} and 0.8 nv_{OC} in response to the open circuit voltage nv_{OC} being available; and
forcing the MPP regulator to regulate the solar array successively at the 0.6 nv_{OC}, 0.7 nv_{OC} and 0.8 nv_{OC} voltages.

3. A method as set forth in claim 1 further defined by:
determining if an open circuit voltage nv_{OC} is available before switching on a regulator;
measuring a first operating point M₁(v₁,i₁) of the solar array in response to the open circuit voltage nv_{OC} not being available; and
setting a second operating point M₂(v₂,i₂) and a third operating point M₃(v₃,i₃) to 1.1 v₁ and 1.2 v₁ in response to the open circuit voltage nv_{OC} not being available.

4. A method as set forth in claim 1 further defined by;
determining when the parameters nA and mi_{R} are required to be refreshed;
determining the first operating point M₁(v₁,i₁) in response to nA and mi_{R} being required to be refreshed wherein v₁ is equal to v_{MPP1} and i₁ is equal to i_{MPP1}; and
solving the three unknown equation system in response to the parameters nA and mi_{R} being required to be refreshed using M₁(v₁,i₁) and the measurements of points M₂(v₂,i₂) and M₃(v₃,i₃) wherein the position of points M₂(v₂,i₂) and M₃(v₃,i₃) is indicated by the sign and amplitude of measured currents Di=(i₁−i_{MPP1}).

5. A method as set forth in claim 1 further defined by:
determining when the power conditioning unit is a sequential Switching Shunt Regulator Process;
determining the first operating point M₁(v₁,i₁) wherein v₁ is the voltage and i₁ is the current in response to the power conditioning unit being a sequential Switching Shunt Regulator Process; and
solving for the last parameter A according to:
$${v}_{1} = \frac{nAkT}{q} Log ( 1 + \frac{m {i}_{SC} - {i}_{1}}{m {i}_{R}} ) \qquad ( 2.15 )$$

6. A method as set forth in claim 1 further defined by:
comparing the value A to a previously calculated value A;
refreshing the paramaters i_{R} and A in response to a difference between the value A and the previously calculated value A;
determining if an open circuit voltage nv_{OC} is available;
measuring the first operating point M₁ in response to the open circuit voltage nv_{OC} being available and a series switch being ON;
evaluating a relationship between the open circuit voltage and the short circuit current and the parameter A according to:
$${nv}_{OC} = \frac{nAkT}{q} Log \frac{{i}_{SC}}{{i}_{R}} = na Log \frac{{i}_{SC}}{{i}_{R}} ; \qquad ( 2.16 )$$
and solving the two equation system as shown by (2.15) and (2.16).

7. A device to operate a solar array to its maximum power point, the device comprising;
a microprocessor PIC (1) to acquire the values of a running point of a solar array via sensors and its temperature via sensor (16) and to process computations (2.19bis), (2.19ter), (2.20), (2.20bis), (2.13) and (2.14) in order to calculate a voltage (2) of the Maximum Power Point to send as a reference command to a power conditioning unit (7) shunt or series type which manages the solar array (5), and
a user network (6) such as an inverter (14) connected to an AC load (15) for receiving an energy.

8. A device as set forth in claim 7 wherein the microprocessor PIC (1) is integrated in the power conditioning unit (7).

9. A device as set forth in claim 7 wherein the voltage (2) of the Maximum Power Point is applied as a reference command in continuous mode to a controller (4) of a regulator.

10. A device as set forth in claim 8 wherein the voltage (2) of the Maximum Power Point is applied as a reference command in continuous mode to a controller (4) of a regulator.

11. A device as set forth in claim 7 wherein the voltage (2) of the Maximum Power Point is applied as a reference command and operated in a sampling mode by a controller (4).

12. A device as set forth in claim 8 wherein the voltage (2) of the Maximum Power Point is applied as a reference command and operated in a sampling mode by a controller (4).
